(19) United States
(12) Patent Application Publication
(10) Pub. No.: US 2012/0210002 A1
(43) Pub. Date: Aug. 16, 2012

(54) DYNAMIC WALLED GARDEN

(76) Inventor: PHILIP A. MCQUADE, Annapolis, MD (US)

(21) Appl. No.: 13/372,198

(22) Filed: Feb. 13, 2012

Related U.S. Application Data
(60) Provisional application No. 61/463,285, filed on Feb. 15, 2011.

(51) Int. Cl. G06F 15/173

(52) U.S. Cl. 709/225

(57) ABSTRACT

A dynamic walled garden access method, apparatus, and system for a local area network. The walled garden access method comprises configuring an indexer to automatically and periodically populate a list of additional permitted locations in a predefined fashion based on a list of initial permitted locations; intercepting, by a network controller/gateway, an access request from a user device; and configuring the network controller/gateway to allow the access request if the access request is on the list of initial permitted locations or the list of additional permitted locations.

### RELATED APPLICATIONS

This application claims priority to U.S. provisional application No. 61/463,285, filed on Feb. 15, 2011, which is hereby incorporated by reference in its entirety.

### FIELD

The present disclosure relates to network controllers or gateways by which user devices obtain access to a network, such as the public Internet. Specifically, the present disclosure relates to a method, system, and apparatus for automatically identifying, selecting, and adding permissible content to supplement previously approved network content instead of being given full access to a network.

### BACKGROUND

Increasing and already extensive use of computers has created a demand for larger networks. Such advancements, however, have corresponding challenges. For example, wide access to a network creates several security risks and/or inefficient use of network resources. Several techniques have been proposed and/or implemented to address these problems. Network controllers or “gateways” are frequently deployed to deliver network access. Network controllers or gateways can restrict a user device's initial access to the network. The restrictions may form a “walled garden” for the user device so that it is only able to access a limited number of websites.

The term “walled garden” is used in several different and distinct contexts in the field of computer networking. This disclosure uses the term in relation to the context of user devices that are controlled by a network controller or gateway in such a way as to initially restrict access to a network, for example a private LAN or the public Internet. For example, a user device initiates a connection to a network through a network controller or gateway, and then the user device is only allowed access to a set of pre-specified locations (the “initial permitted locations”), thus creating a walled garden.

For websites, user devices that are connected to a network controller or gateway creating the “walled garden” are permitted access to destination websites based on the domain name associated with such sites. Permissions can also be granted based on the Fully Qualified Domain Name (“FQDN”) or Uniform Resource Locator (“URL”). The domain names, FQDNs and URLs can be resolved by a Domain Name System (“DNS”) server incorporated into the controller or by other DNS servers on the network.

Currently, the number of user devices is ever growing and the demand for a network connection for various purposes is also growing. Moreover, the nature of the Internet is that it is constantly changing. It is desirable for a network to keep pace with these changes. One particular challenge is to find a way to dynamically and automatically change the attributes of a walled garden.

### SUMMARY

As described more fully below, the embodiments of the present disclosure relate to a dynamic walled garden access method, apparatus, and system for a local area network.

To this end a disclosed walled garden access method for a local area network comprises receiving a list of additional permitted locations and a list of initial permitted locations from an indexer; intercepting, by a network controller or gateway, an access request; and allowing, by the network controller/gateway, the access request if the access request is on the list of initial permitted locations or the list of additional permitted locations.

In some embodiments, the lists of additional permitted locations and initial permitted locations are input from the indexer that is remotely-located from the network controller or the gateway and manages the network controller or the gateway by sending a periodic signal or query to the network controller or gateway. The method may have the indexer initiate contact with the network controller or the gateway whenever a change in either the list of initial permitted locations or the list of additional permitted locations is modified. The method may have the list of initial permitted locations and the list of additional permitted locations include FQDNs and URLs. The method may have the list of initial permitted locations and the list of additional permitted locations include local network addresses.

In another embodiment, a walled garden access apparatus for a local area network comprises an indexer to automatically and periodically populate a list of additional permitted locations in a predefined manner based on a list of initial permitted locations; and a network controller or gateway to intercept an access request from a user device; wherein the network controller or gateway is configured to allow the access request if the access request is on the list of initial permitted locations or the list of additional permitted locations.

In some embodiments, the indexer is located on a different LAN and manages the network controller or the gateway by sending a periodic signal or query to the network controller or gateway. The apparatus may have the indexer initiate contact with the network controller or the gateway whenever a change in either the list of initial permitted locations or the list of additional permitted locations is modified. The apparatus may have the indexer integrated with the network controller or the gateway. The apparatus may have the list of initial permitted locations and the list of additional permitted locations include FQDNs and URLs. The apparatus may have the list of initial permitted locations and the list of additional permitted locations include local network addresses. The apparatus may have the indexer configured to populate the list of additional permitted locations from the insertion of remnant locations. The apparatus may also have the remnant locations as locations that are embedded into a website on very short notice and for an indeterminate period.

In yet another embodiment, a walled garden access system for a local area network comprises a non-transient computer storage medium for storing instructions of an indexer to automatically and periodically populate a list of additional permitted locations in a predefined manner based on a list of initial permitted locations; a processor to execute the instructions of the indexer; a network controller or a gateway, that is connected to a LAN, to intercept an access request; wherein the network controller or the gateway is configured to allow the access request if the access request is on the list of initial permitted locations or the list of additional permitted locations.

In some embodiments, the indexer initiates contact with the network controller or the gateway whenever a change in either the list of initial permitted locations or the list of additional permitted locations is modified. The system may have the indexer initiate contact with the network controller or the gateway whenever a change in either the list of initial permitted locations or the list of additional permitted locations is modified. The system may have the indexer integrated with the network controller or the gateway. The system may have the list of initial permitted locations and the list of additional permitted locations include FQDNs and URLs. The system may have the list of initial permitted locations and the list of additional permitted locations include local network addresses. The system may have the indexer configured to populate the list of additional permitted locations from the insertion of remnant locations.

These, as well as other components, steps, features, objects, benefits, and advantages will now become clear from a review of the following detailed description of illustrative embodiments, the accompanying drawings and the claims. It is to be expressly understood, however, that the drawings are for the purpose of illustration only and are not intended as a definition of the limits of the claimed embodiments.

### BRIEF DESCRIPTION OF THE DRAWINGS

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it is intended to refer to the same or like components or steps.

FIG. 1 is a block diagram illustrating one embodiment of a system according to aspects of the present disclosure.

FIG. 2 illustrates one example of contents of the indexer illustrated in FIG. 1.

FIG. 3 illustrates one example process at the network controller/gateway for creating a dynamic walled garden in accordance with the present disclosure.

FIG. 4 illustrates one possible process 400 for building the list of additional permitted locations in accordance with the present disclosure.

FIGS. 5A and 5B illustrate various configurations of the indexer in relation to a network controller or a gateway.

### DETAILED DESCRIPTION OF ILLUSTRATIVE EMBODIMENTS

As used herein, when two devices are described as “local” to one another the devices are both located within the same local area network (LAN), and when two devices are described as “remote” or “remotely-located”, the devices are not located within the same LAN. For avoidance of ambiguity, the term LAN as used in this application is used in the conventionally understood sense: it is equivalent to the broadcast domain of the underlying Ethernet protocol, or a broadcast domain's equivalent in other, non-Ethernet topologies. In other words, the boundaries of the LAN are at the system routers, and therefore any internet traffic that passes through a system router is crossing the boundaries of the LAN in which it originated.

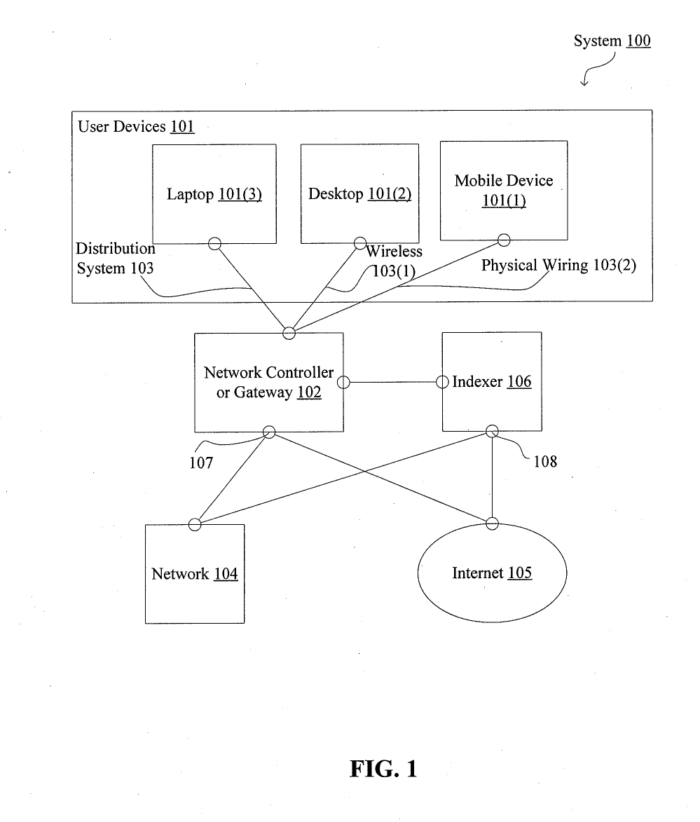

FIG. 1 is a diagram illustrating one embodiment of a system 100 according to aspects of the present disclosure. The system 100 includes user devices 101, a network controller/gateway 102, and an indexer 106 that communicate with a local area network (“LAN”) 104, other local network, and/or the Internet 105. FIG. 1 shows an example of the interaction between the indexer 106 and the network controller/gateway 102 that creates a walled garden for a user device 101. User devices 101, such as e.g., mobile devices 101(1), desktop computers 101(2), and laptop computers 101(3), communicate with the network controller/gateway 102 through a distributions system 103, such as e.g., a direct connection through a physical line 103(2) or a wireless connection 103(1). User devices 101 communicate with the network (i.e., the LAN 104 or the Internet 105) by connecting to the network controller/gateway 102. Access to the network, is limited because the network controller/gateway 102 allows access 107 to destinations that are on a list of “initial permitted locations” and “additional permitted locations” that are populated/maintained by the indexer 106. The indexer 106 monitors the LAN 104 and/or the Internet 105 to add (108) additional locations to the additional permitted locations list.

The embodiment may also be implemented as a computer process, a computing system or as an article of manufacture such as a computer program product. The computer program product may be computer storage medium readable by a computer system and encoding a computer program of instructions for executing a computer process. It should be appreciated that the indexer may be incorporated into the network controller/gateway as a software function (explained below) or that the indexer could also be implemented apart from the network controller/gateway in a separate device.

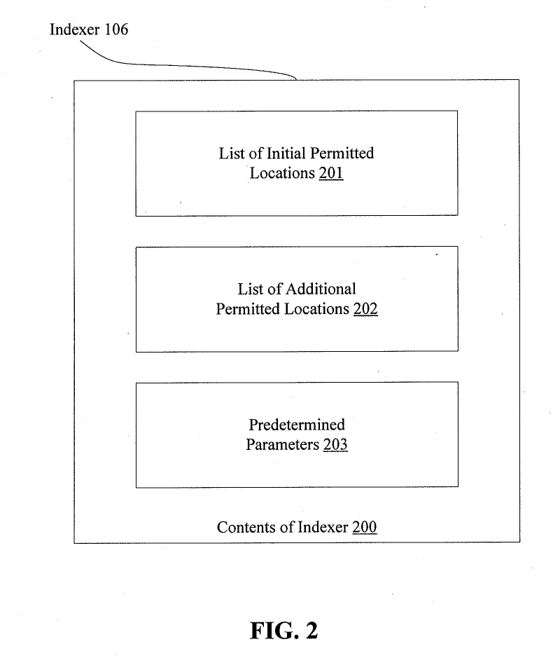

FIG. 2 illustrates example contents 200 of the indexer 106. The illustrated indexer 106 comprises two lists—the initial permitted locations list 201 and the additional permitted locations list 202. The indexer 106 automatically and periodically monitors the content of the initial permitted locations list 201. Then, the indexer 106 automatically populates the additional permitted locations list 202 based on pre-determined parameters 203 such as e.g., depth (i.e., the number of “hops” a location is from the root, where a “hop” means following a link embedded in a location). Once list 202 is generated, user devices 101 will be allowed to access network locations that are on the initial permitted locations list 201 and the additional permitted locations list 202.

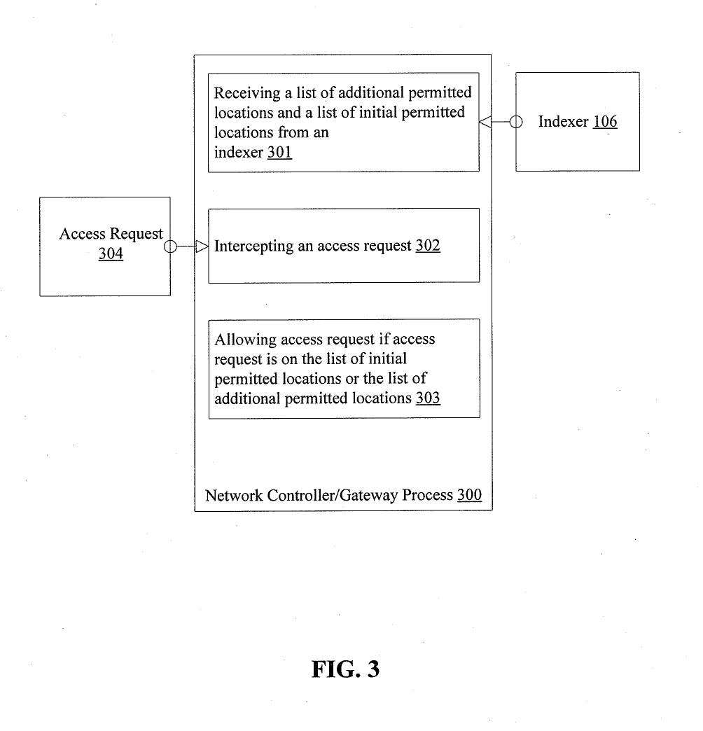

FIG. 3 illustrates one possible process 300 executed at the network controller/gateway for creating/maintaining the dynamic walled garden in accordance with the present disclosure. The process 300 can be implemented in software/computer instructions and executed by a processor contained within the network controller/gateway. In order to create the walled garden, the network controller/gateway receives (at step 301) a list of additional permitted locations and a list of initial permitted locations from an indexer. Then, an access request 304 is intercepted by the network controller/gateway (step 302). Once the access request is intercepted, the network controller/gateway determines (at step 303) whether the destination of the access request is allowed access per the list of initial permitted locations or the list of additional permitted locations.

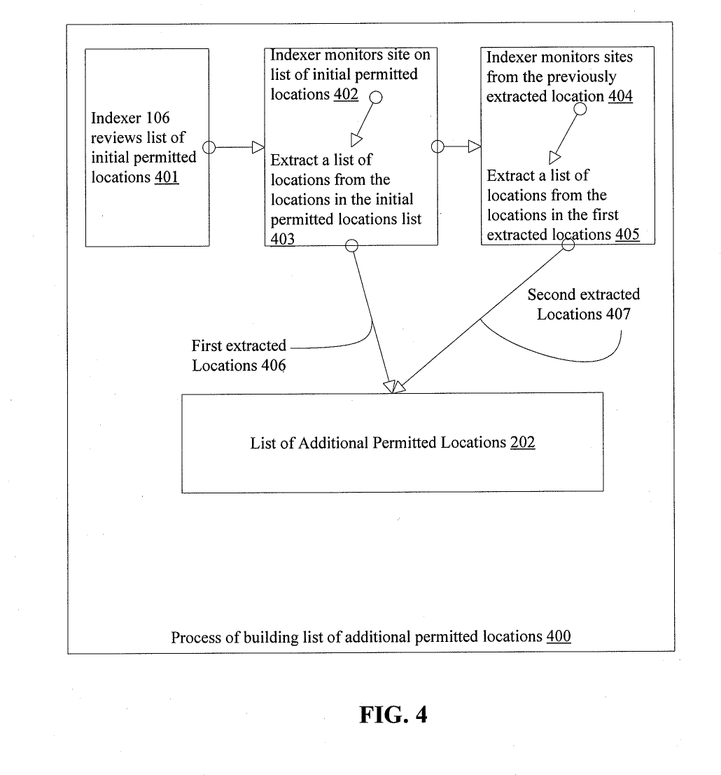

FIG. 4 illustrates one possible process 400 for building the list of additional permitted locations in accordance with the present disclosure. The process 400 can be implemented in software/computer instructions and executed by a processor executing the indexer function or contained within the indexer if the indexer is a separate network component. The indexer 106 builds an initial walled garden based on the list of initial permitted locations (at step 401). Then, the indexer automatically monitors the links of the initial permitted locations (at step 402) using pre-determined parameters to create a list of additional permitted locations 202. At the election of the entity establishing the initial permitted locations 201, pre-determined parameters may be set so that the additional permitted locations may include depth (i.e., the number of “hops” a location is from the root). The entity owning or maintaining the server may specify as many hops as it desires.

For the first hop, the indexer 106 will extract (at step 403) a list of embedded locations from the locations in the initial permitted locations list. This first extracted list 406 will be added to the list of additional permitted locations 202. For the next hop, the indexer 106 will monitor the locations from the first extracted list 406 (at step 404). Then, the indexer will extract (at step 405) a list of embedded locations from the locations in the first extracted list 406, creating a second extracted locations list 407. This second extracted locations list 407 may be stored in the list of additional permitted locations 202. This process may iterate for as many hops as the entity owning or maintaining the server desires or until a predefined number of iterations has occurred.

For example, it is a desirable feature for sponsors of walled garden locations to be able to embed active hyperlinks of URLs to other associated locations, such as e.g., advertisers and other entities related to the entity providing access to the network. In the case of hyperlinks resulting from sales of advertising, such sales by their nature will require that the walled garden not block active hyperlinks to advertiser resources. This embodiment will therefore enable those entities maintaining walled gardens to permit initial access to initial permitted locations, and also, for example, to obtain revenue from advertising sales on the initial permitted locations. This embodiment will permit unrestricted access to the advertiser locations and other hyperlinked resources, i.e., the additional permitted locations, embedded in the initial permitted locations.

Permission to access Internet destination resources can be granted based on domain names, FQDNs or URLs. Domain names, FQDNs and URLs are resolved by default by a DNS server incorporated into the network controller or gateway. This default setting can be modified to direct resolution to a different, specific DNS server or to any available DNS server available on the network. The indexer 106 then dynamically and automatically changes the attributes of the walled garden so that user devices will have access to the linked resources, i.e., the initial permitted locations 201, as well as other associated linked resources, i.e., the additional permitted locations 202. In this situation, the associated linked resources are the additional permitted locations 202 for which hyperlinks are embedded in the initial permitted locations, including the locations of any companies advertising on the initial permitted locations.

Moreover, active hyperlinks related to advertising or to other functions are subject to frequent changes. This disclosure also has the capability to afford automatic access to any resources reachable from hyperlinks embedded in the additional permitted locations, and so on for as many hops as desired.

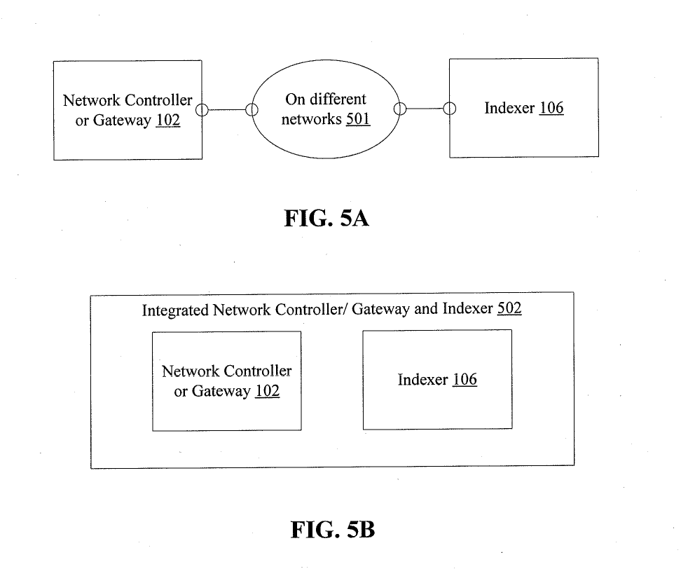

FIG. 5A illustrates one configuration where the indexer 106 and network controller/gateway 102 are located on separate LANs. The indexer 106 offers the updated list for retrieval by network controller/gateway 102 on different networks 501. The indexer 106 may connect to the network controller/gateway 102 through the Internet if desired.

FIG. 5B illustrates one configuration where the indexer 106 and network controller/gateway 102 are integrated into the same device 402. The integrated network controller/gateway and indexer includes a processor and a memory used for implementing the illustrated functions. The memory can be any type of memory suitable for a computer application including, but not limited to, non-transient computer readable memory such as NVRAM. The non-transient computer storage medium stores instructions of an indexer 106 that automatically and periodically populate a list of additional permitted locations in a predefined fashion based on a list of initial permitted locations. That is, the memory can store instructions required for executing process 400. The processor executes these indexer 106 instructions. A network controller or gateway is connected to a LAN and intercepts an access request. Then, the network controller or gateway is configured to allow the access request if the access request is on the list of initial permitted locations or the list of additional permitted locations. The memory could also store instructions suitable for executing controller/gateway process 300.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

What is claimed is:

1. A walled garden access method for a local area network, the method comprising:
receiving a list of additional permitted locations and a list of initial permitted locations from an indexer;
intercepting, by a network controller or gateway, an access request; and
allowing, by the network controller/gateway, the access request if the access request is on the list of initial permitted locations or the list of additional permitted locations.

2. The method of claim 1, wherein lists of additional permitted locations and initial permitted locations are input from the indexer that is remotely-located from the network controller or the gateway and manages the network controller or the gateway by sending a periodic signal or query to the network controller or gateway.

3. The method of claim 2, wherein the indexer initiates contact with the network controller or the gateway whenever a change in either the list of initial permitted locations or the list of additional permitted locations is modified.

4. The method of claim 1, wherein the list of initial permitted locations and the list of additional permitted locations include FQDNs and URLs.

5. The method of claim 1, wherein the list of initial permitted locations and the list of additional permitted locations include local network addresses.

6. A walled garden access apparatus for a local area network, the apparatus comprising:
an indexer to automatically and periodically populate a list of additional permitted locations in a predefined manner based on a list of initial permitted locations; and
a network controller or gateway to intercept an access request from a user device;
wherein the network controller or gateway is configured to allow the access request if the access request is on the list of initial permitted locations or the list of additional permitted locations.

7. The apparatus of claim 6, wherein the indexer is located on a different LAN and manages the network controller or the gateway by sending a periodic signal or query to the network controller or gateway.

8. The apparatus of claim 6, wherein the indexer initiates contact with the network controller or the gateway whenever a change in either the list of initial permitted locations or the list of additional permitted locations is modified.

9. The apparatus of claim 6, wherein the indexer is integrated with the network controller or the gateway.

10. The apparatus of claim 6, wherein the list of initial permitted locations and the list of additional permitted locations include FQDNs and URLs.

11. The apparatus of claim 6, wherein the list of initial permitted locations and the list of additional permitted locations include local network addresses.

12. The apparatus of claim 6, wherein the indexer is configured to populate the list of additional permitted locations from the insertion of remnant locations.

13. The apparatus of claim 12, wherein remnant locations are locations that are embedded into a website on very short notice and for an indeterminate period.

14. A walled garden access system for a local area network, the system comprising:
a non-transient computer storage medium for storing instructions of an indexer to automatically and periodically populate a list of additional permitted locations in a predefined manner based on a list of initial permitted locations;
a processor to execute the instructions of the indexer; and
a network controller or a gateway, that is connected to a LAN, to intercept an access request;
wherein the network controller or the gateway is configured to allow the access request if the access request is on the list of initial permitted locations or the list of additional permitted locations.

15. The system of claim 14, wherein the indexer initiates contact with the network controller or the gateway whenever a change in either the list of initial permitted locations or the list of additional permitted locations is modified.

16. The system of claim 14, wherein the indexer initiates contact with the network controller or the gateway whenever a change in either the list of initial permitted locations or the list of additional permitted locations is modified.

17. The system of claim 14, wherein the indexer is integrated with the network controller or the gateway.

18. The system of claim 14, wherein the list of initial permitted locations and the list of additional permitted locations include FQDNs and URLs.

19. The system of claim 14, wherein the list of initial permitted locations and the list of additional permitted locations include local network addresses.

20. The system of claim 14, wherein the indexer is configured to populate the list of additional permitted locations from the insertion of remnant locations.
